(19) United States
(12) Patent Application Publication
(10) Pub. No.: US 2012/0012723 A1
(43) Pub. Date: Jan. 19, 2012

(54) LIGHTER-HOLDER FOR WATER PIPE APPARATUS AND METHODS

(76) Inventor: Zachary C. Mansfield, Paso Robles, CA (US)

(21) Appl. No.: 12/835,507

(22) Filed: Jul. 13, 2010

(51) Int. Cl. F16B 2/08; B23P 11/00

(52) U.S. Cl. 248/230.8; 29/428

(57) ABSTRACT

A lighter-holder apparatus for use with a water pipe involving a flexible collar. The flexible collar includes a gripping feature for accommodating a lighter and a hooking feature for facilitating disposition of the apparatus around the water pipe. The hooking feature is coupled with the gripping feature.

### BACKGROUND OF THE INVENTION

1. Field of the Invention

The present invention generally relates to water pipes. More specifically, the present invention generally relates to accessories for use with water pipes. Even more specifically, the present invention generally relates to lighter-holders for use with water pipes.

2. Discussion of the Related Art

In the related art, water pipes and their accessories have been used since ancient time. An example of a primitive water pipe is a hookah, the use of which has recently resurged. The hookah is a large water pipe that has originated in India, but the hookah has since been gaining popularity in the Middle East, primarily in Turkey and Iran, as well as around the world. The hookah comprises a single-stemmed, or a multi-stemmed, large pipe that utilizes water and indirect heat for smoking a substance, wherein smoke is cooled and filtered by passing it through the water. These water pipes are usually fabricated from a glass and/or a metal.

Another example of a water pipe is the bong: a filtration and cooling device for smoking substances. The construction of a bong is similar to that of a hookah. The functions of bongs and hookahs are similar. A bong comprises an air-tight and water-tight vessel, a screened bowl, and a stem portion, sometimes referred to as a “slide.” The word bong is an adaptation of the That word “baung,” denoting a cylindrical wooden tube, pipe, or container fabricated from for smoking. Bongs have been in use traditionally by the Hmong people of Laos and Thailand for centuries. Bongs are typically fabricated by hand-blowing glass. As such, bong sizing is rarely uniform.

In order to ignite the smoking material, an incendiary device, such as a match or a modern lighter is needed. For modern water pipes, modern fluid lighters are typically used, but are also readily misplaced. One related art accessory for holding a modern lighter comprises a piece of textile wrapped and knotted around the water pipe and the lighter. However, this accessory is cumbersome to use and requires a great deal of manual dexterity by the user. This related accessory, itself, is also easily misplaced and does not have significant longevity.

### SUMMARY OF THE INVENTION

Several embodiments of the invention advantageously address the needs above as well as other needs by providing a lighter-holder apparatus that is handy, portable, convenient, and conducive to easy removable installation and repositioning on a variety of water pipes and for a variety of lighters. The present lighter-holder apparatus is conducive to moderately frictional engagement of a smooth surface, such as clean glass, providing considerable longevity of use by virtue of its materials of construction, such as rubber, and accommodates a plurality of lighter types and lighter configurations.

In one embodiment, the invention can be characterized as a lighter-holder apparatus for use with a water pipe, the apparatus comprising a flexible collar, the flexible collar comprising at least one gripping feature for accommodating a lighter and a hooking feature for facilitating disposition of the apparatus around the water pipe, the hooking feature being coupled with the at least one gripping feature.

In an alternative embodiment, the invention can be characterized as a method of fabricating a lighter-holder apparatus for use with a water pipe, the method generally comprising providing a flexible collar, the flexible collar providing step comprising providing at least one gripping feature for accommodating a lighter, providing a hooking feature for facilitating disposition of the apparatus around the water pipe, and coupling the hooking feature with the at least one gripping feature.

In yet another embodiment, the invention can be characterized as a method of using a lighter-holder apparatus with a water pipe, the method generally comprising providing a flexible collar, the flexible collar providing step comprising providing at least one gripping feature for accommodating a lighter, providing a hooking feature for facilitating disposition of the apparatus around the water pipe, coupling the hooking feature with the at least one gripping feature, disposing the flexible collar around the water pipe, and disposing a lighter in the at least one gripping feature.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a frontal perspective view diagram of a lighter-holder apparatus for use with a water pipe, the apparatus being installed on the water pipe, in accordance with a first embodiment of the present invention.

FIG. 2 is a rearward perspective view diagram of the lighter-holder apparatus for use with a water pipe, the apparatus being installed on the water pipe, in accordance with the first embodiment of the present invention as shown in FIG. 1.

FIG. 3 is a perspective view diagram of the lighter-holder apparatus for use with a water pipe, the apparatus comprising a gripping feature in a parallel orientation in relation to the flexible collar or the water pipe, in accordance with the first embodiment of the present invention as shown in FIG. 1.

FIG. 4 is a side view diagram of the lighter-holder apparatus for use with a water pipe, the apparatus comprising a gripping feature in a parallel orientation in relation to the flexible collar or the water pipe, wherein the opposing side view (not shown) is a minor image thereof, in accordance with the first embodiment of the present invention as shown in FIG. 1.

FIG. 5 is a top view diagram of the lighter-holder apparatus for use with a water pipe, the apparatus comprising a gripping feature in a parallel orientation in relation to the flexible collar or the water pipe, wherein the opposing side view (not shown) is a mirror image thereof, in accordance with the first embodiment of the present invention as shown in FIG. 1.

FIG. 6 is a perspective view diagram of a lighter-holder apparatus for use with a water pipe, the apparatus comprising a gripping feature in a parallel orientation in relation to the flexible collar or the water pipe, the gripping feature comprising grips and arms being of comparable height, in accordance with a second embodiment of the present invention.

FIG. 7 is a side view diagram of the lighter-holder apparatus for use with a water pipe, the apparatus comprising a gripping feature in a parallel orientation in relation to the flexible collar or the water pipe, the gripping feature comprising grips and arms being of comparable height, in accordance with the second embodiment of the present invention as shown in FIG. 6.

FIG. 8 is a top view diagram of the lighter-holder apparatus for use with a water pipe, the apparatus comprising a gripping feature in a parallel orientation in relation to the flexible collar or the water pipe, the gripping feature comprising grips and antis being of comparable height, in accordance with the second embodiment of the present invention as shown in FIG. 6.

FIG. 9 is a perspective view diagram of a lighter-holder apparatus for use with a water pipe, the apparatus comprising a plurality of gripping features, in accordance with a third embodiment of the present invention.

FIG. 10 is a side view diagram of the lighter-holder apparatus for use with a water pipe, the apparatus comprising a plurality of gripping features, in accordance with the third embodiment of the present invention as shown in FIG. 9.

FIG. 11 is a top view diagram of the lighter-holder apparatus for use with a water pipe, the apparatus comprising a plurality of gripping features, in accordance with the third embodiment of the present invention as shown in FIG. 9.

FIG. 12 is a perspective view diagram of a lighter-holder apparatus for use with a water pipe, the apparatus comprising a gripping feature in a perpendicular orientation in relation to the flexible collar or the water pipe, in accordance with a fourth embodiment of the present invention.

FIG. 13 is a side view diagram of the lighter-holder apparatus for use with a water pipe, the apparatus comprising a gripping feature in a perpendicular orientation in relation to the flexible collar or the water pipe, in accordance with the fourth embodiment of the present invention as shown in FIG. 12.

FIG. 14 is a top view diagram of the lighter-holder apparatus for use with a water pipe, the apparatus comprising a gripping feature in a perpendicular orientation in relation to the flexible collar or the water pipe, in accordance with the fourth embodiment of the present invention as shown in FIG. 12.

FIG. 15 is a perspective view diagram of a lighter-holder apparatus for use with a water pipe, the apparatus comprising a rotating feature, in accordance with a fifth embodiment of the present invention.

FIG. 16 is a side view diagram of the lighter-holder apparatus for use with a water pipe, the apparatus comprising a rotating feature, in accordance with the fifth embodiment of the present invention as shown in FIG. 15.

FIG. 17 is a top view diagram of the lighter-holder apparatus for use with a water pipe, the apparatus comprising a rotating feature, in accordance with the fifth embodiment of the present invention as shown in FIG. 15.

FIG. 18 is an exploded view of the lighter-holder apparatus for use with a water pipe, the apparatus comprising a rotating feature, in accordance with the fifth embodiment of the present invention as shown in FIG. 15.

FIG. 19 is a perspective view of a gripping feature of the lighter-holder apparatus for use with a water pipe, the apparatus comprising a rotating feature, and the gripping feature being rotated clockwise by way of the rotating feature, in accordance with the fifth embodiment of the present invention as shown in FIG. 15.

FIG. 20 is a perspective view of a gripping feature of the lighter-holder apparatus for use with a water pipe, the apparatus comprising a rotating feature, and the gripping feature being rotated counterclockwise by way of the rotating feature, in accordance with the fifth embodiment of the present invention as shown in FIG. 15.

FIG. 21 is a perspective view diagram of a lighter-holder apparatus for use with a water pipe, the apparatus comprising an enhanced retention feature, in accordance with a sixth embodiment of the present invention.

FIG. 22 is a side view diagram of the lighter-holder apparatus for use with a water pipe, the apparatus comprising an enhanced retention feature, in accordance with the sixth embodiment of the present invention as shown in FIG. 21.

FIG. 23 is a top view diagram of the lighter-holder apparatus for use with a water pipe, the apparatus comprising an enhanced retention feature, in accordance with the sixth embodiment of the present invention as shown in FIG. 21.

FIG. 24 is a frontal exploded view of the lighter-holder apparatus for use with a water pipe, the apparatus comprising an enhanced retention feature, in accordance with the sixth embodiment of the present invention as shown in FIG. 21.

FIG. 25 is a rearward exploded view of the lighter-holder apparatus for use with a water pipe, the apparatus comprising an enhanced retention feature, in accordance with the sixth embodiment of the present invention as shown in FIG. 21.

FIG. 26 is a flowchart of a method of fabricating a lighter-holder apparatus for use with a water pipe, in accordance with another alternative embodiment of the present invention.

FIG. 27 is a flowchart of a method for using a lighter-holder apparatus for use with a water pipe, in accordance with another alternative embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims. For a better understanding of the present invention, reference is made to the below-referenced accompanying Drawing(s). Reference numbers refer to the same or equivalent parts of the present invention throughout the several figures of the Drawing(s).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of gripping and hooking features, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Some embodiments of the present invention generally involve a lighter-holder apparatus for use with a water pipe, the apparatus comprising a flexible collar, the flexible collar comprising a gripping feature for accommodating a lighter and a hooking feature for facilitating disposition of the apparatus around the water pipe, the hooking feature being coupled with the gripping feature.

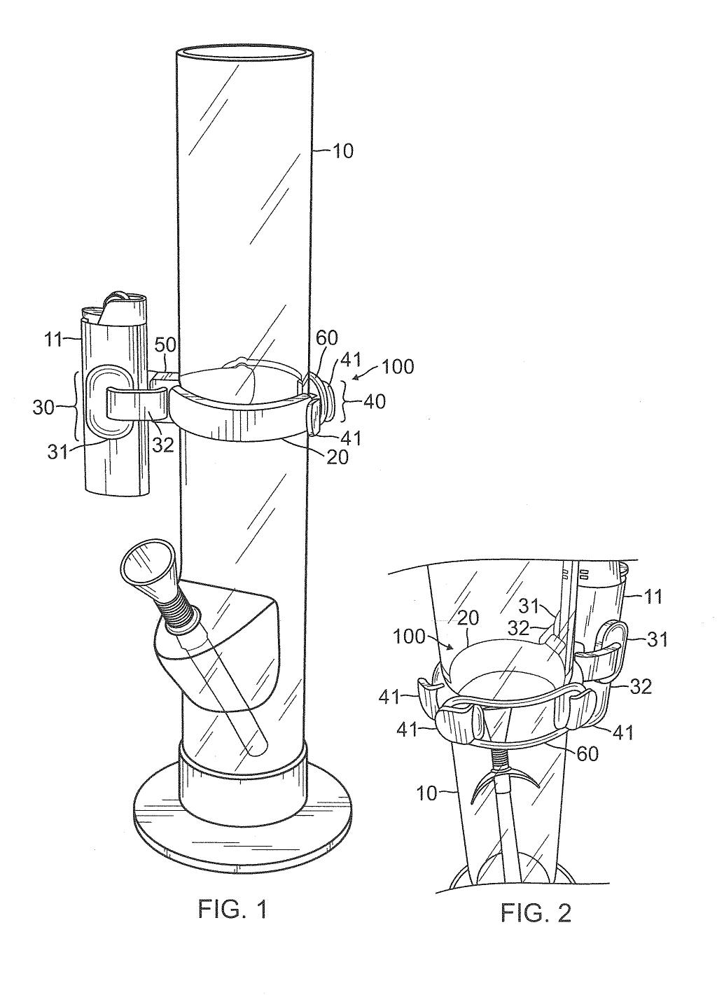

Referring first to FIG. 1, this frontal perspective view diagram illustrates a lighter-holder apparatus 100 for use with a water pipe 10, the apparatus 100 being installed on the water pipe 10, in accordance with a first embodiment of the present invention. The apparatus 100 generally comprises a flexible collar 20. The flexible collar 20, in turn, comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The center post 50 comprises a solid construction. The elastic member 60 comprises an element, such as a rubber band and any other elastic band.

Still referring to FIG. 1, the flexible collar 20 is disposed (removably) around the water pipe 10. The elastic member 60 is disposed (removably) around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The at least one hook 41 is coupled with the flexible collar 20, e.g., in a spaced-apart configuration.

Still referring to FIG. 1, in operation, the gripping feature 30 accommodates the lighter 11 while the hooking feature 40 facilitates disposition of the apparatus 100, by way of the flexible collar 20, around the water pipe 10. The elastic member 60 is disposed around the hooking feature 40 for facilitating fit of the apparatus 100 around the water pipe 10, via compressing the flexible collar 20 against, and frictionally engaging the flexible collar 20 with, the water pipe 10. Generally, the apparatus 100 accommodates water pipes 10, having a diameter of approximately 1⅜″ to approximately 3″. The center post 50 functions as a stabilizer and prevents the distance between the arms 32 from becoming too wide or too narrow, e.g., maintaining an optimal distance while the flexible collar 20 is being disposed around the water pipe 10.

Referring next to FIG. 2, this rearward perspective view diagram illustrates the lighter-holder apparatus 100 for use with a water pipe 10, the apparatus 100 being installed on the water pipe 10, in accordance with the first embodiment of the present invention as shown in FIG. 1. The apparatus 100 comprises a flexible collar 20. The flexible collar 20, in turn, comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The elastic member 60 comprises a rubber band, by example only. The at least one grip 31 comprises a concave surface 33 (FIG. 5). Alternatively, the at least one grip 31 comprises a flat surface (not shown). The collar 20 comprises at least one frangible portion (not shown), corresponding to each at least one hook 41. The gripping feature 30 is oriented in parallel with the water pipe 10 in this embodiment. The apparatus 100 comprises a flexible or elastic material, such as rubber.

Still referring to FIG. 2, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The elastic member 60 is stretched around the at least one hook 41. The at least one grip 31 comprises a concave surface 33 (FIG. 5) for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section.

Still referring to FIG. 2, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

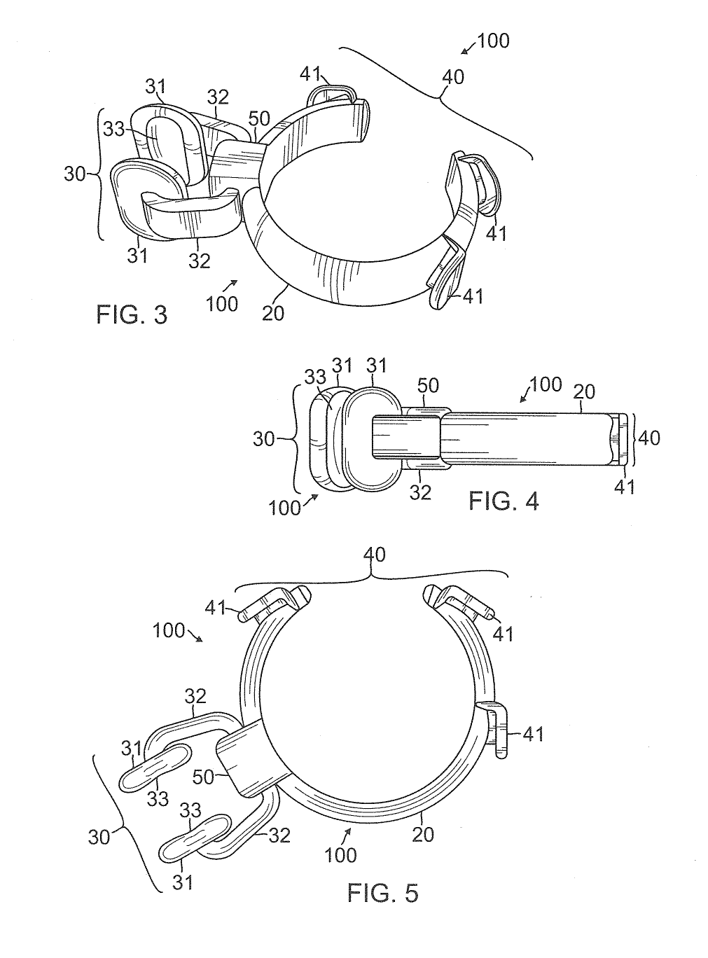

Referring next to FIG. 3, this perspective view diagram illustrates the lighter-holder apparatus 100 for use with a water pipe 10, the apparatus 100 comprising a gripping feature 30 in a “parallel” orientation in relation to the flexible collar 20 or the water pipe 10, in accordance with the first embodiment of the present invention as shown in FIG. 1. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33, for example. Alternatively, the at least one grip 31 comprises a flat surface (not shown). The collar 20 comprises at least one frangible portion (not shown), corresponding to each at least one hook 41. The gripping feature 30 is oriented in parallel with the water pipe 10 in this embodiment. The apparatus 100 comprises a flexible or elastic material, such as rubber.

Still referring to FIG. 3, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with flexible collar 20.

Still referring to FIG. 3, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and/or the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

Referring next to FIG. 4, this side view diagram illustrates the lighter-holder apparatus 100 for use with a water pipe 10, the apparatus 100 comprising a gripping feature 30 in a parallel orientation in relation to the flexible collar 20 or the water pipe 10, wherein the opposing side view (not shown) is a mirror image thereof, in accordance with the first embodiment of the present invention as shown in FIG. 1. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33. Alternatively, the at least one grip 31 comprises a flat surface (not shown). The collar 20 comprises at least one frangible portion (not shown), corresponding to each at least one hook 41. The gripping feature 30 is oriented in parallel with the water pipe 10 in this embodiment. The apparatus 100 comprises a flexible or elastic material, such as rubber.

Still referring to FIG. 4, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20.

Still referring to FIG. 4, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and/or the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

Referring next to FIG. 5, this top view diagram illustrates the lighter-holder apparatus 100 for use with a water pipe 10, the apparatus 100 comprising a gripping feature 30 in a “parallel” orientation in relation to the flexible collar 20 or the water pipe 10, wherein the opposing side view (not shown) is a mirror image thereof, in accordance with the first embodiment of the present invention as shown in FIG. 1. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33. Alternatively, the at least one grip 31 comprises a flat surface (not shown). The collar 20 comprises at least one frangible portion (not shown), corresponding to each at least one hook 41. The gripping feature 30 is oriented in parallel with the water pipe 10 in this embodiment. The apparatus 100 comprises a flexible or elastic material, such as rubber.

Still referring to FIG. 5, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20.

Still referring to FIG. 5, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and/or the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

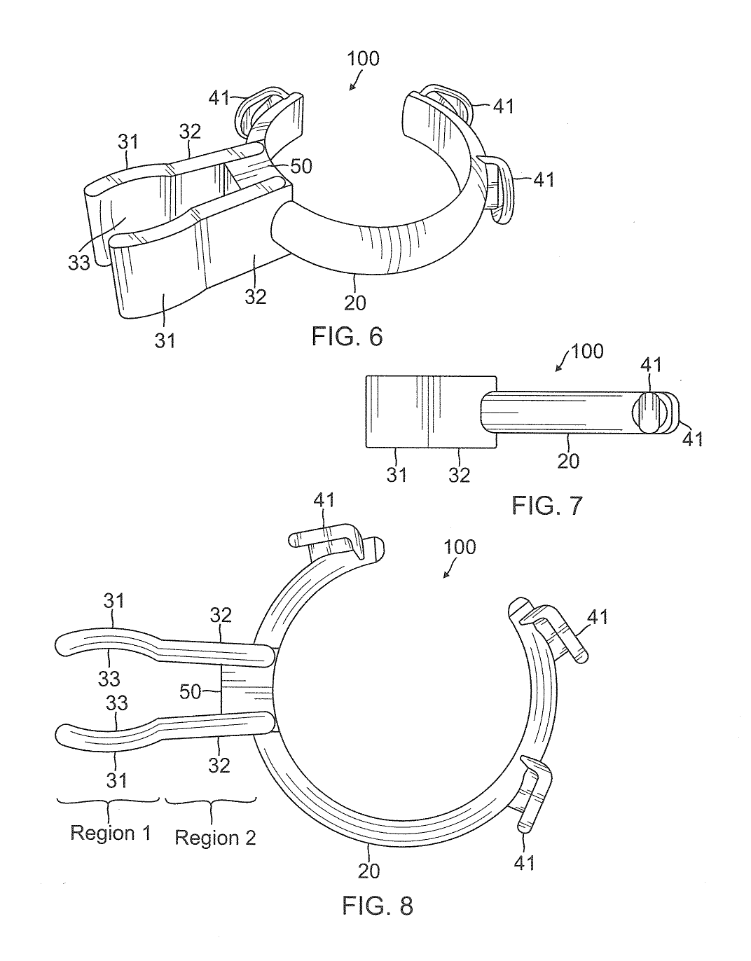

Referring next to FIG. 6, this perspective view diagram illustrates the lighter-holder apparatus 100 for use with a water pipe 10, the apparatus 100 comprising a gripping feature 30 in a “parallel” orientation in relation to the flexible collar 20 or the water pipe, the gripping feature comprising grips and arms being of comparable height, in accordance with a second embodiment of the present invention. The apparatus 100 comprises a flexible collar 20. The flexible collar 20 comprises a gripping feature 30 and a hooking feature 40. The gripping feature 30 comprises at least one grip 31 and at least one atm 32. The at least one grip 31 and the at least one arm comprise a height of approximately ⅞″. The hooking feature 40 comprises at least one hook 41. The apparatus 100 further comprises a center post 50 and an elastic member 60, by example only. The elastic member 60 comprises a rubber band, by example only. The at least one grip 31 comprises a concave surface 33. The at least one arm 32 comprises a flat surface. The collar 20 comprises at least one frangible portion (not shown), corresponding to each at least one hook 41. The gripping feature 30 is oriented in parallel with the water pipe 10 in this embodiment. The apparatus 100 comprises a flexible or elastic material, such as rubber. Region 1 comprises the space defined between a pair of grips 31; and Region 2 comprises the space defined between a pair of arms 32.

Still referring to FIG. 6, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The elastic member 60 is stretched around the at least one hook 41. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The center post 50 may also be disposed between a pair of arms 32.

Still referring to FIG. 6, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. The at least one arm 32 comprises a flat surface for accommodating a plurality of lighter configurations, such as a rectangular cross-section and a square cross-section. The user would merely slide the lighter 11 against either the at least one grip 31 or the at least one arm 32 to achieve the desired fit. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

Referring next to FIG. 7, this side view diagram illustrates the lighter-holder apparatus 100 for use with a water pipe 10, the apparatus 100 comprising a gripping feature 30 in a parallel orientation in relation to the flexible collar 20 or the water pipe 10, the gripping feature 30 comprising grips 31 and arms 32 being of comparable height, in accordance with the second embodiment of the present invention as shown in FIG. 6. The apparatus 100 comprises a flexible collar 20. The flexible collar 20 comprises a gripping feature 30 and a hooking feature 40. The gripping feature 30 comprises at least one grip 31 and at least one arm 32. The at least one grip 31 and the at least one arm 32 comprise a height of approximately ⅞″. The hooking feature 40 comprises at least one hook 41. The apparatus 100 further comprises a center post 50 and an elastic member 60, by example only. The elastic member 60 comprises a rubber band, by example only. The at least one grip 31 comprises a concave surface 33. The at least one arm 32 comprises a flat surface. The collar 20 comprises at least one frangible portion (not shown), corresponding to each at least one hook 41. The gripping feature 30 is oriented in parallel with the water pipe 10 in this embodiment. The apparatus 100 comprises a flexible or elastic material, such as rubber. Region 1 comprises the space defined between a pair of grips 31; and Region 2 comprises the space defined between a pair of arms 32.

Still referring to FIG. 7, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The elastic member 60 is stretched around the at least one hook 41. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The center post 50 may also be disposed between a pair of arms 32.

Still referring to FIG. 7, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. The at least one arm 32 comprises a flat surface for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

Referring next to FIG. 8, this top view diagram illustrates the lighter-holder apparatus 100 for use with a water pipe 10, the apparatus 100 comprising a gripping feature 30 in a “parallel” orientation in relation to the flexible collar 20 or the water pipe 10, the gripping feature 30 comprising grips 31 and arms 32 being of comparable height, in accordance with the second embodiment of the present invention as shown in FIG. 6. The apparatus 100 comprises a flexible collar 20. The flexible collar 20 comprises a gripping feature 30 and a hooking feature 40. The gripping feature 30 comprises at least one grip 31 and at least one arm 32. The at least one grip 31 and the at least one arm 32 comprise a height of approximately ⅞″. The hooking feature 40 comprises at least one hook 41. The apparatus 100 further comprises a center post 50 and an elastic member 60, by example only. The elastic member 60 comprises a rubber band, by example only. The at least one grip 31 comprises a concave surface 33. The at least one arm 32 comprises a flat surface. The collar 20 comprises at least one frangible portion (not shown), corresponding to each at least one hook 41. The gripping feature 30 is oriented in parallel with the water pipe 10 in this embodiment. The apparatus 100 comprises a flexible or elastic material, such as rubber. Region 1 comprises the space defined between a pair of grips 31; and region 2 comprises the space defined between a pair of arms 32.

Still referring to FIG. 8, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The elastic member 60 is stretched around the at least one hook 41. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The center post 50 may also be disposed between a pair of arms 32.

Still referring to FIG. 8, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. The at least one arm 32 comprises a flat surface for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

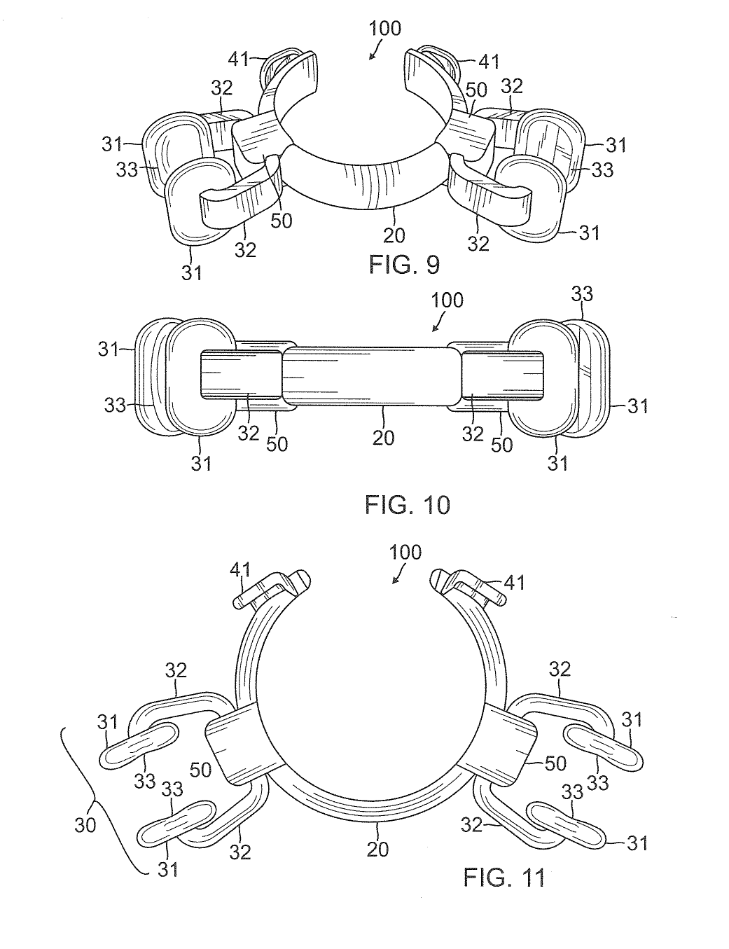

Referring next to FIG. 9, this perspective view diagram illustrates the lighter-holder apparatus 100 for use with a water pipe 10, the apparatus 100 comprising a plurality of gripping features 30, in accordance with a third embodiment of the present invention. The apparatus 100 comprises a flexible collar 20. The flexible collar 20 comprises at least one gripping feature 30, e.g., a pair of gripping features 30, and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 9, the flexible collar 20 is disposed around the water pipe 10. The elastic member 60 is disposed around the hooking feature 40. The gripping feature 30 is coupled with the hooking feature 40 by way of the center post 50. At least one lighter 11 is removably disposed within the at least one gripping feature 30. The at least one grip 31 is coupled with the center post 50 by the at least one arm 32. The at least one gripping feature 30 is oriented in parallel with the water pipe 10 in this embodiment. The at least one hook 41 is coupled with the flexible collar 20.

Still referring to FIG. 9, in operation, the at least one gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 accommodates both left-handed users as well as right-handed users from either side of the apparatus 100, i.e., the apparatus 100 is ambidextrous, without the need to re-orient the apparatus 100.

Referring next to FIG. 10, this side view diagram illustrates the lighter-holder apparatus 100 for use with a water pipe 10, the apparatus 100 comprising a plurality of gripping features 30, in accordance with the third embodiment of the present invention as shown in FIG. 9. The apparatus 100 comprises a flexible collar 20. The flexible collar 20 comprises at least one gripping feature 30, e.g., a pair of gripping features 30, and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 10, the flexible collar 20 is disposed around the water pipe 10. The elastic member 60 is disposed around the hooking feature 40. The gripping feature 30 is coupled with the hooking feature 40 by way of the center post 50. At least one lighter 11 is removably disposed within the at least one gripping feature 30. The at least one grip 31 is coupled with the center post 50 by the at least one arm 32. The at least one gripping feature 30 is oriented in parallel with the water pipe 10 in this embodiment. The at least one hook 41 is coupled with the flexible collar 20.

Still referring to FIG. 10, in operation, the at least one gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 accommodates both left-handed users as well as right-handed users from either side of the apparatus 100, i.e., the apparatus 100 is ambidextrous, without the need to re-orient the apparatus 100.

Referring next to FIG. 11, this top view diagram illustrates the lighter-holder apparatus 100 for use with a water pipe 10, the apparatus 100 comprising a plurality of gripping features 30, in accordance with the third embodiment of the present invention as shown in FIG. 9. The apparatus 100 comprises a flexible collar 20. The flexible collar 20 comprises at least one gripping feature 30, e.g., a pair of gripping features 30, and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 11, the flexible collar 20 is disposed around the water pipe 10. The elastic member 60 is disposed around the hooking feature 40. The gripping feature 30 is coupled with the hooking feature 40 by way of the center post 50. At least one lighter 11 is removably disposed within the at least one gripping feature 30. The at least one grip 31 is coupled with the center post 50 by the at least one arm 32. The at least one gripping feature 30 is oriented in parallel with the water pipe 10 in this embodiment. The at least one hook 41 is coupled with the flexible collar 20.

Still referring to FIG. 11, in operation, the at least one gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 accommodates both left-handed users as well as right-handed users from either side of the apparatus 100, i.e., the apparatus 100 is ambidextrous, without the need to re-orient the apparatus 100.

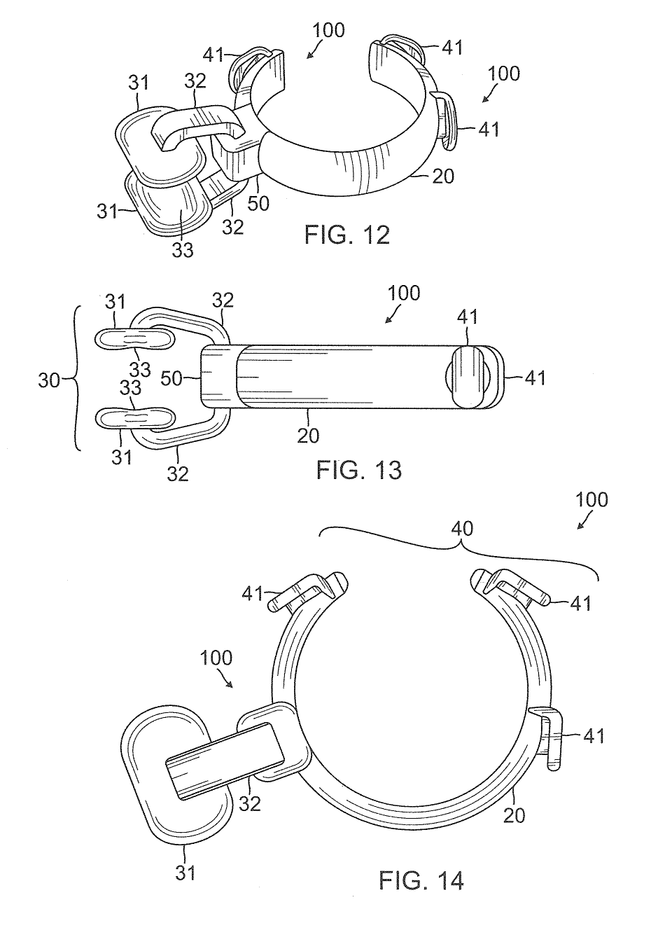

Referring next to FIG. 12, this perspective view diagram illustrates the lighter-holder apparatus 100 for use with a water pipe 10, the apparatus 100 comprising a gripping feature 30 in a perpendicular orientation in relation to the flexible collar 20 or the water pipe 10, in accordance with a fourth embodiment of the present invention. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33. Alternatively, the at least one grip 31 comprises a flat surface (not shown). The flexible collar 20 comprises at least one frangible portion (not shown), corresponding to each at least one hook 41. The apparatus 100 comprises a flexible or elastic material, such as rubber.

Still referring to FIG. 12, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in perpendicular to the water pipe 10 in this embodiment. The at least one hook 41 is coupled with the flexible collar 20.

Still referring to FIG. 12, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

Referring next to FIG. 13, this side view diagram illustrates the lighter-holder apparatus 100 for use with a water pipe 10, the apparatus 100 comprising a gripping feature 30 in a perpendicular orientation in relation to the flexible collar 20 or the water pipe 10, in accordance with a fourth embodiment of the present invention as shown in FIG. 12. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 13, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in perpendicular to the water pipe 10 in this embodiment. The at least one hook 41 is coupled with the flexible collar 20.

Still referring to FIG. 13, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

Referring next to FIG. 14, this top view diagram illustrates the lighter-holder apparatus 100 for use with a water pipe 10, the apparatus 100 comprising a gripping feature 30 in a perpendicular orientation in relation to the flexible collar 20 or the water pipe 10, in accordance with a fourth embodiment of the present invention as shown in FIG. 12. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 14, the flexible collar 20 is disposed around the water pipe 10. The elastic member 50 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in perpendicular to the water pipe 10 in this embodiment. The at least one hook 41 is coupled with the flexible collar 20.

Still referring to FIG. 14, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous.

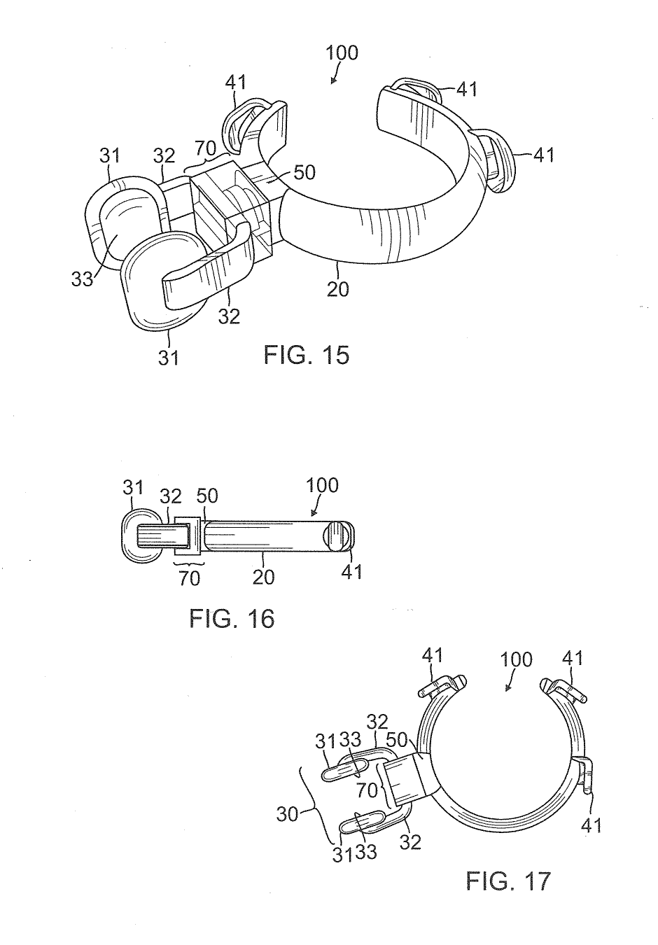

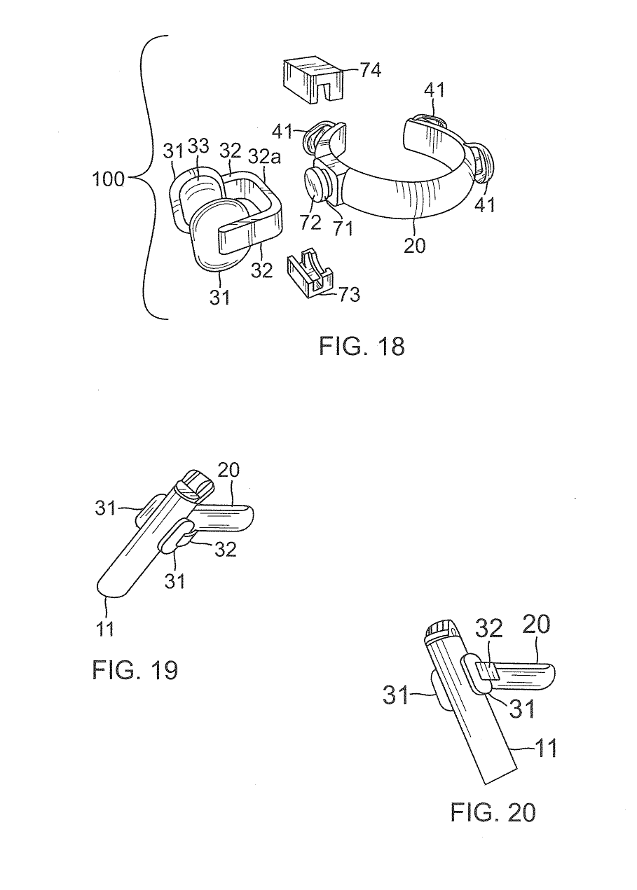

Referring next to FIG. 15, this perspective view diagram illustrates the lighter-holder apparatus 100 for use with a water pipe 10, the apparatus 100 comprising a rotating feature 70, in accordance with a fifth embodiment of the present invention. The apparatus 100 comprises a flexible collar 20. The flexible collar 20 comprises a gripping feature 30 and a hooking feature 40. The gripping feature 30 comprises at least one grip 31 and at least one arm 32 having an arm connection 32a (FIG. 18). The hooking feature 40 comprises at least one hook 41. The apparatus 100 further comprises a center post 50 and an elastic member 60, by example only. The apparatus 100 further comprises a rotating feature 70 coupled with the center post 50 and with the gripping feature 30, the rotating feature 70 comprising a ring portion 71, an anchor portion 72, a shell portion 73, and a box portion 74 (FIG. 18). The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 15, the flexible collar 20 is disposed around the water pipe 10. The elastic member 60 is disposed around the hooking, feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one arm 32 is coupled together by the arm connection 32a (FIG. 8). The at least one hook 41 is coupled with the flexible collar 20. The rotating feature 70 is coupled with the center post 50 and with the gripping feature 30. In the rotating feature 70, the ring portion 71 is coupled with the center post 50 and the anchor portion 72. The shell portion 73 is coupled with the gripping feature 30 by way of the at least one arm 32 and with the box portion 74 via a groove found in the shell portion 73 (FIG. 18). The box portion 74 retains the arms 32 in place by way of an arm connector 32a (FIG. 18).

Still referring to FIG. 15, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one atm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. Further, the rotating feature 70 facilitates rotational disposition of the gripping feature 30 in relation to the collar 20 at any desired angle. The box portion 74 and the shell portion 73 are rotated by rotating the gripping feature 30 about the anchor portion 72 (FIG. 18).

Referring next to FIG. 16, this side view diagram illustrates the lighter-holder apparatus 100 for use with a water pipe 10, the apparatus 100 comprising a rotating feature 70, in accordance with the fifth embodiment of the present invention as shown in FIG. 15. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The apparatus 100 further comprises a rotating feature 70 coupled with the center post 50 and with the gripping feature 30, the rotating feature 70 comprising a ring portion 71, an anchor portion 72, a shell portion 73, and a box portion 74 (FIG. 18). The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 16, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The rotating feature 70 is coupled with the center post 50 and with the gripping feature 30. In the rotating feature 70, the ring portion 71 is coupled with the center post 50 and the anchor portion 72 (FIG. 18). The shell portion 73 is coupled with the gripping feature 30 by way of the at least one arm 32 and with the box portion 74 (FIG. 18).

Still referring to FIG. 16, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. Further, the rotating feature 70 facilitates rotational disposition of the gripping feature 30 in relation to the collar 20.

Referring next to FIG. 17, this top view diagram illustrates the lighter-holder apparatus 100 for use with a water pipe 10, the apparatus 100 comprising a rotating feature 70, in accordance with the fifth embodiment of the present invention as shown in FIG. 15. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The apparatus 100 further comprises a rotating feature 70 coupled with the center post 50 and with the gripping feature 30, the rotating feature 70 comprising a ring portion 71, an anchor portion 72, a shell portion 73, and a box portion 74 (FIG. 18). The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 17, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The rotating feature 70 is coupled with the center post 50 and with the gripping feature 30. In the rotating feature 70, the ring portion 71 is coupled with the center post 50 and the anchor portion 72 (FIG. 18). The shell portion 73 is coupled with the gripping feature 30 by way of the at least one arm 32 and with the box portion 74 (FIG. 18).

Still referring to FIG. 17, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. Further, the rotating feature 70 facilitates rotational disposition of the gripping feature 30 in relation to the collar 20.

Referring next to FIG. 18, this exploded view illustrates the lighter-holder apparatus 100 for use with a water pipe 10, the apparatus 100 comprising a rotating feature 70, in accordance with the fifth embodiment of the present invention as shown in FIG. 15. The apparatus 100 comprises a flexible collar 20. The flexible collar 20 comprises a gripping feature 30 and a hooking feature 40. The gripping feature 30 comprises at least one grip 31 and at least one arm 32. The hooking feature 40 comprises at least one hook 41. The apparatus 100 further comprises a center post 50 and an elastic member 60, by example only. The apparatus 100 further comprises a rotating feature 70 coupled with the center post 50 and with the gripping feature 30, the rotating feature 70 comprising a ring portion 71, an anchor portion 72, a shell portion 73, and a box portion 74. The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 18, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The rotating feature 70 is coupled with the center post 50 and with the gripping feature 30. In the rotating feature 70, the ring portion 71 is coupled with the center post 50 and the anchor portion 72. The shell portion 73 is coupled with the gripping feature 30 by way of the at least one arm 32 and with the box portion 74.

Still referring to FIG. 18, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. Further, the rotating feature 70 facilitates rotational disposition of the gripping feature 30 in relation to the collar 20.

Referring next to FIG. 19, this perspective view illustrates the gripping feature 30 of the lighter-holder apparatus 100 for use with a water pipe 10, the apparatus 100 comprising a rotating feature 70, and the gripping feature 30 being rotated clockwise by way of the rotating feature 70, in accordance with the fifth embodiment of the present invention as shown in FIG. 15. The apparatus 100 further comprises the rotating feature 70 coupled with the center post 50 and with the gripping feature 30, the rotating feature 70 comprising a ring portion 71, an anchor portion 72, a shell portion 73, and a box portion 74. The rotating feature 70 is coupled with the center post 50 and with the gripping feature 30. In the rotating feature 70, the ring portion 71 is coupled with the center post 50 and the anchor portion 72. The shell portion 73 is coupled with the gripping feature 30 by way of the at least one arm 32 and with the box portion 74. Further, the rotating feature 70 facilitates rotational disposition of the gripping feature 30 in relation to the collar 20 to any desired angular position, e.g., to an angle of approximately 45° for example as shown in FIG. 19, thereby providing an ergonomic apparatus 100.

Referring next to FIG. 20, this perspective view illustrates the gripping feature 30 of the lighter-holder apparatus 100 for use with a water pipe 10, the apparatus 100 comprising a rotating feature 70, and the gripping feature 30 being rotated counterclockwise by way of the rotating feature 70, in accordance with the fifth embodiment of the present invention as shown in FIG. 15 The apparatus 100 further comprises a rotating feature 70 coupled with the center post 50 and with the gripping feature 30, the rotating feature 70 comprising a ring portion 71, an anchor portion 72, a shell portion 73, and a box portion 74. The rotating feature 70 is coupled with the center post 50 and with the gripping feature 30. In the rotating feature 70, the ring portion 71 is coupled with the center post 50 and the anchor portion 72. The shell portion 73 is coupled with the gripping feature 30 by way of the at least one arm 32 and with the box portion 74. Further, the rotating feature 70 facilitates rotational disposition of the gripping feature 30 in relation to the collar 20 to any desired angular position, e.g., to an angle of approximately −45° for example as shown in FIG. 20, thereby providing an ergonomic apparatus 100.

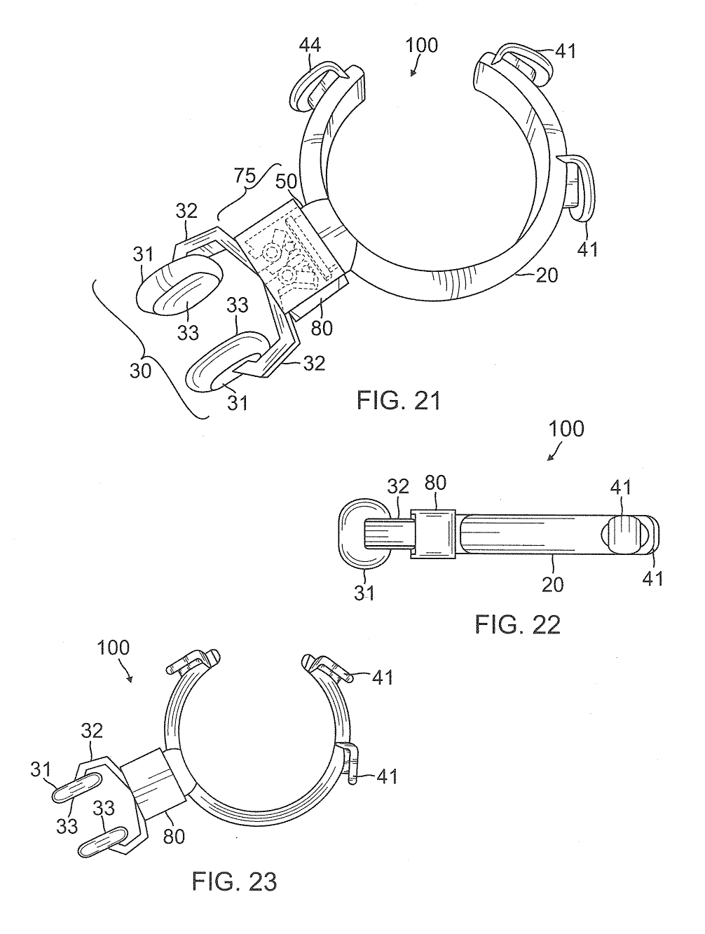

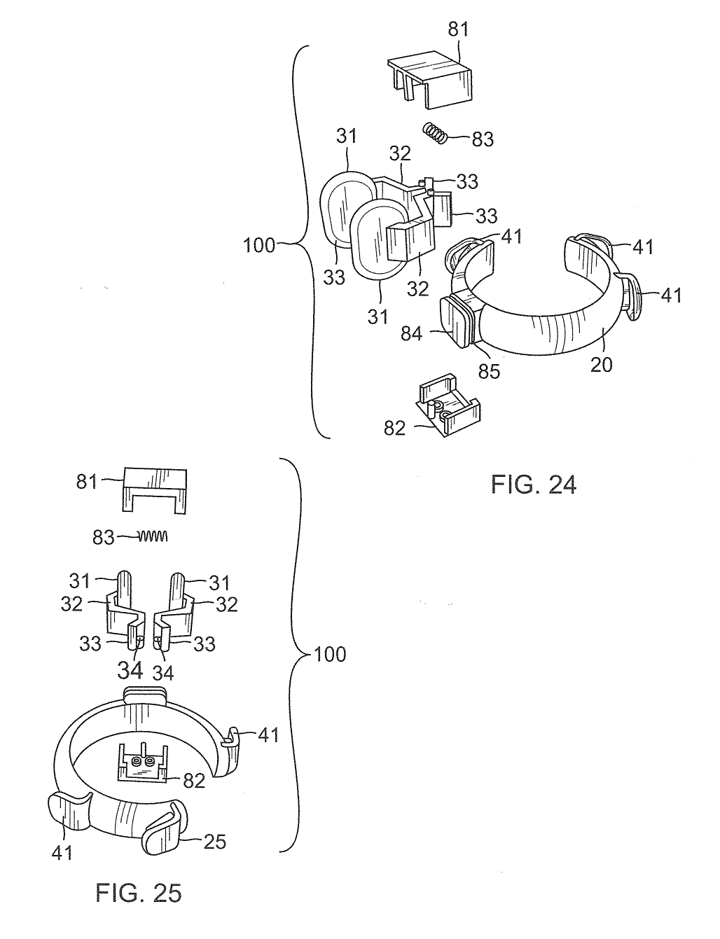

Referring next to FIG. 21, this perspective view diagram illustrates the lighter-holder apparatus 100 for use with a water pipe 10, the apparatus 100 comprising an enhanced retention feature 75, in accordance with a sixth embodiment of the present invention. The flexible collar 20 comprises a gripping feature 30 and a hooking feature 40. The gripping feature 30 comprises at least one grip 31 and at least one atm 32. The at least one grip comprises a material, such as an elastic or flexible polymer, e.g., rubber. The at least one arm comprises a material, such as a polymer, e.g., a plastic. The hooking feature 40 comprises at least one hook 41. Each at least one arm 32 further comprises a flange portion 33 having a pin portion 34. The apparatus 100 further comprises a center post 50 and an elastic member 60, by example only. The enhanced retention 75 feature comprises a box portion 80 coupled with the center post 50 and with the gripping feature 30, the box portion 80 comprising an upper shell portion 81 and a lower shell portion 82 (FIG. 24). The enhanced retention feature further comprises a spring 83, an anchor portion 84, and a neck portion 85 (FIG. 24). The box position 80 comprises a material, such as a polymer, e.g., a rigid plastic. The spring 83 comprises a material, such as metal (FIG. 24). The upper and lower shell portions 81, 82 respectively comprise a grooved portion (FIG. 24). The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 21, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The box portion 80 is coupled with the center post 50 and with the gripping feature 30. In the box portion 80, the neck portion 85 is coupled with the center post 50 and the anchor portion 84 (FIG. 24). The flange portions 33 of the arms 32 are disposed within the upper shell portion 81 and the lower shell portion 82, wherein a portion of the arms 32 extend through the box portion 80 (FIG. 24). The spring 83 is retained by the pin portions 34 of the flange portions 33 (FIG. 24). The grooved portions of upper and lower shell portions 81, 82, are respectively coupled with the anchor portion 84 (FIG. 24).

Still referring to FIG. 21, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. The upper and lower shell portions 81, 82 respectively comprise a grooved portion for accommodating the anchor portion 84 (FIG. 24). Further, the enhanced retention feature, comprising the box portion 80, facilitates retaining the disposition of the arms 32 until they are further separated by the lighter 11 and further facilitates gripping of the lighter 11, since the spring 83 exerts a force on the arms 32 (FIG. 24).

Referring next to FIG. 22, this side view diagram illustrates the lighter-holder apparatus 100 for use with a water pipe 10, the apparatus 100 comprising an enhanced retention feature 75, in accordance with a sixth embodiment of the present invention as shown in FIG. 21. The flexible collar 20 comprises a gripping feature 30 and a hooking feature 40. The gripping feature 30 comprises at least one grip 31 and at least one arm 32. The at least one grip comprises a material, such as an elastic or flexible polymer, e.g., rubber. The at least one arm comprises a material, such as a polymer, e.g., a plastic. The hooking feature 40 comprises at least one hook 41. Each at least one arm 32 further comprises a flange portion 33 having a pin portion 34 (FIG. 25). The apparatus 100 further comprises a center post 50 and an elastic member 60, by example only. The apparatus 100 further comprises an enhanced retention feature, comprising a box portion 80 coupled with the center post 50 and with the gripping feature 30, the box portion 80 comprising an upper shell portion 81 and a lower shell portion 82 (FIG. 24). The enhanced retention feature further comprises a spring 83, an anchor portion 84, and a neck portion 85 (FIG. 24). The box portion 80 comprises a material, such as a polymer, e.g., a rigid plastic. The spring 83 comprises a material, such as metal (FIG. 24). The upper and lower shell portions 81, 82 respectively comprise a grooved portion (FIG. 24). The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 22, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The box portion 80 is coupled with the center post 50 and with the gripping feature 30. In the box portion 80, the neck portion 85 is coupled with the center post 50 and the anchor portion 84 (FIG. 24). The flange portions 33 of the arms 32 are disposed within the upper shell portion 81 and the lower shell portion 82, wherein a portion of the arms 32 extend through the box portion 80 (FIG. 24). The spring 83 is retained by the pin portions 34 of the flange portions 33 (FIG. 24). The grooved portions of upper and lower shell portions 81, 82, are respectively coupled with the anchor portion 84 (FIG. 24).

Still referring to FIG. 22, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. The upper and lower shell portions 81, 82 respectively comprise a grooved portion for accommodating the anchor portion 84 (FIG. 24). Further, the enhanced retention feature, comprising the box portion 80, facilitates retaining the disposition of the arms 32 until they are further separated by the lighter 11 and further facilitates gripping of the lighter 11, since the spring 83 exerts a force on the arms 32 (FIG. 25).

Referring next to FIG. 23, this top view diagram illustrates the lighter-holder apparatus 100 for use with a water pipe 10, the apparatus 100 comprising an enhanced retention feature 75, in accordance with a sixth embodiment of the present invention as shown in FIG. 21. The flexible collar 20 comprises a gripping feature 30 and a hooking feature 40. The gripping feature 30 comprises at least one grip 31 and at least one arm 32. The at least one grip comprises a material, such as an elastic or flexible polymer, e.g., rubber. The at least one arm comprises a material, such as a polymer, e.g., a plastic. The hooking feature 40 comprises at least one hook 41. Each at least one arm 32 further comprises a flange portion 33 having a pin portion 34 (FIG. 25). The apparatus 100 further comprises a center post 50 and an elastic member 60, by example only. The apparatus 100 further comprises an enhanced retention feature, comprising a box portion 80 coupled with the center post 50 and with the gripping feature 30, the box portion 80 comprising an upper shell portion 81 and a lower shell portion 82 (FIG. 24). The enhanced retention feature further comprises a spring 83, an anchor portion 84, and a neck portion 85 (FIG. 24). The box portion 80 comprises a material, such as a polymer, e.g., a rigid plastic. The spring 83 comprises a material, such as metal (FIG. 24). The upper and lower shell portions 81, 82 respectively comprise a grooved portion (FIG. 24). The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 23, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The box portion 80 is coupled with the center post 50 and with the gripping feature 30. In the box portion 80, the neck portion 85 is coupled with the center post 50 and the anchor portion 84 (FIG. 24). The flange portions 33 of the arms 32 are disposed within the upper shell portion 81 and the lower shell portion 82, wherein a portion of the arms 32 extend through the box portion 80 (FIG. 24). The spring 83 is retained by the pin portions 34 of the flange portions 33 (FIG. 24). The grooved portions of upper and lower shell portions 81, 82, are respectively coupled with the anchor portion 84 (FIG. 24).

Still referring to FIG. 23, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and all ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. The upper and lower shell portions 81, 82 respectively comprise a grooved portion for accommodating the anchor portion 84 (FIG. 24). Further, the enhanced retention feature, comprising the box portion 80, facilitates retaining the disposition of the arms 32 until they are further separated by the lighter 11 and further facilitates gripping of the lighter 11, since the spring 83 exerts a force on the arms 32 (FIG. 25).

Referring next to FIG. 24, this frontal exploded view illustrates the lighter-holder apparatus 100 for use with a water pipe 10, the apparatus 100 comprising an enhanced retention feature 75, in accordance with a sixth embodiment of the present invention as shown in FIG. 21. The flexible collar 20 comprises a gripping feature 30 and a hooking feature 40. The gripping feature 30 comprises at least one grip 31 and at least one arm 32. The at least one grip comprises a material, such as an elastic or flexible polymer, e.g., rubber. The at least one arm comprises a material, such as a polymer, e.g., a plastic. The hooking feature 40 comprises at least one hook 41. Each at least one arm 32 further comprises a flange portion 33 having a pin portion 34 (FIG. 25). The apparatus 100 further comprises a center post 50 and an elastic member 60, by example only. The apparatus 100 further comprises an enhanced retention feature, comprising a box portion 80 coupled with the center post 50 and with the gripping feature 30, the box portion 80 comprising an upper shell portion 81 and a lower shell portion 82. The enhanced retention feature further comprises a spring 83, an anchor portion 84, and a neck portion 85. The portion box 80 comprises a material, such as a polymer, e.g., a rigid plastic. The spring 83 comprises a material, such as metal. The upper and lower shell portions 81, 82 respectively comprise a grooved portion. The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 24, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The box portion 80 is coupled with the center post 50 and with the gripping feature 30. In the box portion 80, the neck portion 85 is coupled with the center post 50 and the anchor portion 84. The flange portions 33 of the arms 32 are disposed within the upper shell portion 81 and the lower shell portion 82, wherein a portion of the arms 32 extend through the box portion 80. The spring 83 is retained by the pin portions 34 of the flange portions 33 (FIG. 25). The grooved portions of upper and lower shell portions 81, 82, are respectively coupled with the anchor portion 84.

Still referring to FIG. 24, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. The upper and lower shell portions 81, 82 respectively comprise a grooved portion for accommodating the anchor portion 84. Further, the enhanced retention feature, comprising the box portion 80, facilitates retaining the disposition of the arms 32 until they are further separated by the lighter 11 and further facilitates gripping of the lighter 11, since the spring 83 exerts a force on the arms 32.

Referring next to FIG. 25, this rearward exploded view illustrates the lighter-holder apparatus 100 for use with a water pipe 10, the apparatus 100 comprising an enhanced retention feature 75, in accordance with a sixth embodiment of the present invention as shown in FIG. 21. The flexible collar 20 comprises a gripping feature 30 and a hooking feature 40. The gripping feature 30 comprises at least one grip 31 and at least one arm 32. The at least one grip comprises a material, such as an elastic or flexible polymer, e.g., rubber. The at least one arm comprises a material, such as a polymer, e.g., a plastic. The hooking feature 40 comprises at least one hook 41. Each at least one arm 32 further comprises a flange portion 33 having a pin portion 34. The apparatus 100 further comprises a center post 50 and an elastic member 60, by example only. The apparatus 100 further comprises an enhanced retention feature, comprising a box portion 80 coupled with the center post 50 and with the gripping feature 30, the box portion 80 comprising an upper shell portion 81 and a lower shell portion 82. The enhanced retention feature further comprises a spring 83, an anchor portion 84, and a neck portion 85. The box portion 80 comprises a material, such as a polymer, e.g., a rigid plastic. The spring 83 comprises a material, such as metal. The upper and lower shell portions 81, 82 respectively comprise a grooved portion. The at least one grip 31 comprises a concave surface 33. Alternatively, the at least one grip 31 comprises a flat surface (not shown). The collar 20 comprises at least one frangible portion (not shown), corresponding to each at least one hook 41. The apparatus 100 comprises a flexible or elastic material, such as rubber.

Still referring to FIG. 25, the flexible collar 20 is disposed around the water pipe 10. The elastic member 60 is disposed around the hooking feature 40. The gripping feature 30 is coupled with the hooking feature 40 by way of the center post 50. A lighter 11 is removably disposed within the gripping feature 30. The at least one grip 31 is coupled with the center post 50 by the at least one arm 32. The gripping feature 30 is oriented in parallel with the water pipe 10 in this embodiment. The at least one hook 41 is coupled with the flexible collar 20. The box portion 80 is coupled with the center post 50 and with the gripping feature 30. In the box portion 80, the neck portion 85 is coupled with the center post 50 and the anchor portion 84. The flange portions 33 of the arms 32 are disposed within the upper shell portion 81 and the lower shell portion 82, wherein a portion of the arms 32 extend through the box portion 80. The spring 83 is retained by the pin portions 34 of the flange portions 33. The grooved portions of upper and lower shell portions 81, 82, are respectively coupled with the anchor portion 84.

Still referring to FIG. 25, in operation, the gripping feature 30 accommodates the lighter 11 while the hooking feature 40 facilitates disposition of the apparatus 100 around the water pipe 10. The elastic member 60 is disposed around the hooking feature 40 for facilitating fit of the apparatus 100 around the water pipe 10. The center post 50 maintains the at least one arm 32 in a fixed position while the collar 20 is being stretched around the water pipe 10, thereby providing structural integrity and stability, regardless of the shape and the size of the water pipe 10. The at least one hook 41 provides an expandable locking system for accommodating a plurality of water pipe sizes. The at least one grip 31 comprises a concave surface 33 for accommodating a plurality of lighter configurations, such as an oval cross-section, an elliptical cross-section, and an ogivoidal cross-section. Alternatively, the at least one grip 31 comprises a flat surface (not shown) for accommodating a plurality of lighter configurations, such as a rectangular cross-section and a square cross-section. The collar 20 comprises at least one frangible portion (not shown), corresponding to each at least one hook 41, for facilitating custom-fit (universal sizing) of the apparatus 100 around any given water pipe 10. The apparatus 100 may be reverse-oriented for accommodating both left-handed users as well as right-handed users, i.e., the apparatus 100 is ambidextrous. The upper and lower shell portions 81, 82 respectively comprise a grooved portion for accommodating the anchor portion 84. Further, the enhanced retention feature, comprising the box portion 80, facilitates retaining the disposition of the arms 32 until they are further separated by the lighter 11 and further facilitates gripping of the lighter 11, since the spring 83 exerts a force on the arms 32.

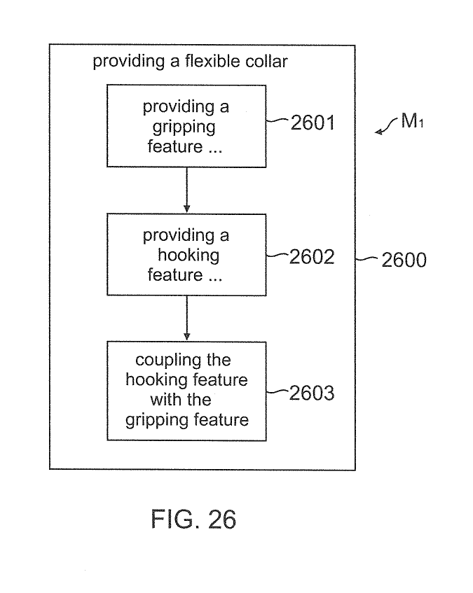

Referring next to FIG. 26, this flowchart illustrates a method M₁ of fabricating a lighter-holder apparatus 100 for use with a water pipe 10, in accordance with another alternative embodiment of the present invention. The method M₁ generally comprises providing a flexible collar 20, as indicated by block 2600. The flexible collar 20 providing step 2600 comprises providing a gripping feature 30 for accommodating a lighter 11, as indicated by block 2601, providing a hooking feature 40 for facilitating disposition of the apparatus 100 around the water pipe 10, as indicated by block 2602, and coupling the hooking feature 40 with the gripping feature 30, as indicated by block 2603.

Still referring to FIG. 26, the method M₁ further comprises providing a stabilizer, such as a center post 50, for coupling the hooking feature 40 with the gripping feature 30. The gripping feature 30 providing step 2601 comprises providing at least one arm 32 for accommodating at least one lighter type and at least one lighter configuration. The stabilizer providing step comprises coupling the hooking feature 40 with the gripping feature 30, via the center post 50 for example, in a manner such that the apparatus is ambidextrous by way of reversible orientation. The at least one arm 32 providing step comprises providing a padding feature, such as at least one grip 31. The padding feature providing step comprises providing a configuration, such as a concave surface for accommodating a lighter 11 having an oval cross-section and a flat surface for accommodating a lighter 11 having a rectangular cross-section. The at least one lighter type comprises an element, such as a permanent lighter and a disposable lighter. The at least one lighter 11 comprises a configuration, such as an oval configuration and a rectangular configuration.

Still referring to FIG. 26, in the method M₁ collar 20 providing step 2600 comprises providing the flexible collar 20 as being frangible for facilitating fit of the apparatus 100 around the water pipe 10. The flexible collar 20 providing step comprises providing the flexible collar 20 with an interference fit for facilitating fit of the apparatus 100 around the water pipe 10. The hooking feature 40 providing step 2602 comprises providing at least one hook 41 for accommodating an elastic member 60. The at least one hook 41 providing step comprises providing the at least one hook 41 as being frangible for facilitating fit of the apparatus 100 around the water pipe 10. The at least one hook 41 providing step comprises providing the elastic member 60 as at least one element, such as a rubber band. The flexible collar 20 providing step 2600 comprises providing the flexible collar 20 being capable of accommodating a plurality of water pipe sizes. The flexible collar 20 providing step 2600 comprises forming the flexible collar 20 from a material, such as a flexible polymer, an elastomer, and a rubber. Alternatively, the flexible collar 20 providing step 2600 may comprise providing the flexible collar 20 as being frangible itself, such as having frangible portions corresponding to the at least one hook 41 for customizing fit of the apparatus 100 for any given water pipe 10.

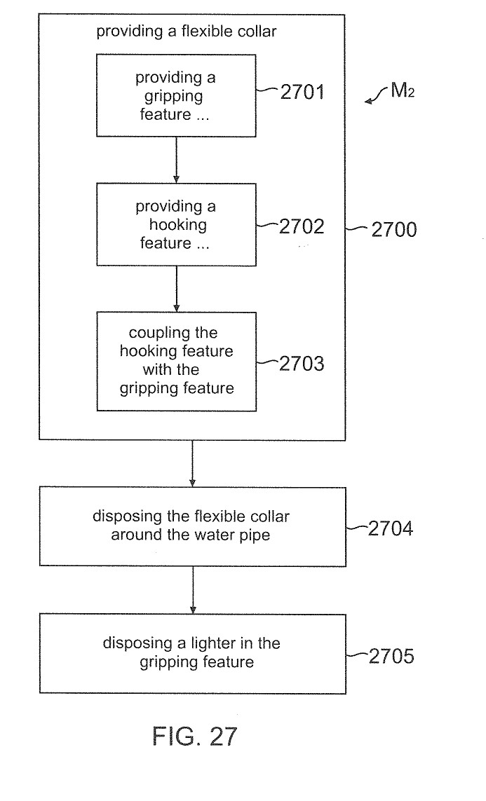

Referring finally to FIG. 27, this flowchart illustrates a method M₂ for using a lighter-holder apparatus 100 with a water pipe 10, in accordance with another alternative embodiment of the present invention. The method M₂ generally comprises providing a flexible collar 20, as indicated by block 2700, the flexible collar 20 providing step 2700 comprising providing a gripping feature for accommodating a lighter, as indicated by block 2701, providing a hooking feature for facilitating disposition of the apparatus around the water pipe, as indicated by block 2702, and coupling the hooking feature with the gripping feature, as indicated by block 2703; disposing the flexible collar 20 around the water pipe 10, as indicated by block 2704; and disposing a lighter 11 in the gripping feature 30 as indicated by block 2705. The method M₂ further comprises disposing an elastic member 60 around the hooking feature 40 for further securing of the apparatus 100 to the water pipe 10. The method of M₂ may further comprise the steps of reversing the orientation of the apparatus 100 in relation to the water pipe 10 (not shown) and rotating the gripping feature 30 in relation to the flexible collar 20 (not shown).

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a system or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, that various changes and modifications in form, material, and fabrication material detail may be made, without departing from the spirit and scope of the invention as set forth in the appended claims, should be readily apparent to those of ordinary skill in the art.

What is claimed:

1. A lighter-holder apparatus for use with a water pipe, the apparatus comprising a flexible collar, the flexible collar comprising:
at least one gripping feature for accommodating at least one lighter; and
a hooking feature for facilitating disposition of the apparatus around the water pipe, the hooking feature being coupled with the at least one gripping feature.

2. The apparatus of claim 1, further comprising at least one stabilizer for coupling the hooking feature with the at least one gripping feature,
wherein the at least one gripping feature comprises at least one arm and at least one grip respectively coupled with the at least one arm for accommodating at least one lighter type and at least one lighter configuration,
wherein the at least one stabilizer maintains an optimal distance between a pair of arms during disposition of the flexible collar around the water pipe, having a given size, and
wherein the apparatus is ambidextrous by way of reversible orientation.

3. The apparatus of claim 2,
wherein the at least one grip comprises a padding feature, and
wherein the padding feature comprises a configuration selected from a group consisting essentially of a concave surface for accommodating a lighter having an oval cross-section and a flat surface for accommodating a lighter having a rectangular cross-section.

4. The apparatus of claim 2,
wherein the at least one lighter type comprises an element selected from a group consisting essentially of a permanent lighter and a disposable lighter, and
wherein the at least one lighter comprises a configuration selected from a group consisting essentially of an oval configuration and a rectangular configuration.

5. The apparatus of claim 1,
wherein the flexible collar is frangible for facilitating fit of the apparatus around the water pipe,
wherein the flexible collar comprises interference fit for facilitating fit of the apparatus around the water pipe,
wherein the hooking feature comprises a thematic feature,
wherein the hooking feature comprises at least one hook for accommodating an elastic member, and
wherein the at least one hook is frangible for facilitating fit of the apparatus around the water pipe.

6. The apparatus of claim 1,
wherein the at least one grip comprises a concave surface for accommodating a lighter having an oval cross-section,
wherein the at least one arm comprises a flat surface for accommodating a lighter having a rectangular cross-section, and
wherein the at least one grip and the at least one arm are approximately equal in height.

7. The apparatus of claim 1,
wherein the at least one gripping feature is orientable in a manner selected from a group consisting essentially of in parallel with the flexible collar, perpendicular to the flexible collar, and in any desired angular relation to the flexible collar, and
wherein the flexible collar accommodates a plurality of water pipe sizes.

8. The apparatus of claim further comprising a feature selected from a group consisting essentially of:
at least one rotating feature coupled with the at least one stabilizer and with the at least one gripping feature for facilitating orientation of the at least one gripping feature in relation to the flexible collar; and
at least one enhanced retention feature for increasing a gripping force being applied to the at least one lighter.

9. The apparatus of claim 8,
wherein the at least one rotating feature comprises a ring portion, an anchor portion, a shell portion, and a box portion,
wherein the ring portion is coupled with the at least one stabilizer and the anchor portion, and
wherein the shell portion is coupled with the at least one gripping feature by way of the at least one arm and with the box portion.

10. The apparatus of claim 8.
wherein the at least one enhanced retention feature comprises a box portion coupled with the at least one stabilizer and with the at least one gripping feature, a spring, an anchor portion, and a neck portion,
wherein the box portion comprises an upper shell portion and a lower shell portion, and
wherein the upper and lower shell portions respectively comprise a grooved portion for accommodating the anchor portion.

11. The apparatus of claim 10,
wherein the box portion comprises at least one material selected from a group consisting essentially of a polymer, and a rigid plastic, and
wherein the spring comprises at least one material selected from a group consisting essentially of a metal, and an alloy.

12. The apparatus of claim 5,
wherein the elastic member comprises at least one element selected from a group consisting essentially of a rubber band, and
wherein the flexible collar comprises a material selected from a group consisting essentially of a flexible polymer, an elastomer, and a rubber.

13. The apparatus of claim 1, further comprising:
at least one stabilizer for coupling the hooking feature with the at least one gripping feature; and
a feature selected from a group consisting essentially of:
at least one rotating feature coupled with the at least one stabilizer and with the at least one gripping feature for facilitating orientation of the at least one gripping feature in relation to the flexible collar; and
at least one enhanced retention feature for increasing a gripping force being applied to the at least one lighter,
wherein the at least one gripping feature comprises at least one arm and at least one grip respectively coupled with the at least one arm for accommodating at least one lighter type and at least one lighter configuration,
wherein the apparatus is ambidextrous by way of reversible orientation,
wherein the at least one grip comprises a padding feature,
wherein the padding feature comprises a configuration selected from a group consisting essentially of a concave surface for accommodating a lighter having an oval cross-section and a flat surface for accommodating a lighter having a rectangular cross-section,
wherein the at least one lighter type comprises an element selected from a group consisting essentially of a permanent lighter and a disposable lighter,
wherein the at least one lighter comprises a configuration selected from a group consisting essentially of an oval configuration and a rectangular configuration,
wherein the flexible collar is frangible for facilitating fit of the apparatus around the water pipe,
wherein the flexible collar comprises interference fit for facilitating fit of the apparatus around the water pipe,
wherein the hooking feature comprises a thematic feature,
wherein the hooking feature comprises at least one hook for accommodating an elastic member,
wherein the at least one hook is frangible for facilitating fit of the apparatus around the water pipe,
wherein the at least one grip comprises a concave surface for accommodating a lighter having an oval cross-section,
wherein the at least one arm comprises a flat surface for accommodating a lighter having a rectangular cross-section,
wherein the at least one grip and the at least one arm are approximately equal in height,
wherein the at least one gripping feature is orientable in a manner selected from a group consisting essentially of in parallel with the flexible collar, perpendicular to the flexible collar, and in any desired angular relation to the flexible collar.
wherein the flexible collar accommodates a plurality of water pipe sizes,
wherein the at least one rotating feature comprises a ring portion, an anchor portion, a shell portion, and a box portion,
wherein the ring portion is coupled with the at least one stabilizer and the anchor portion,
wherein the shell portion is coupled with the at least one gripping feature by way of the at least one arm and with the box portion,
wherein the at least one enhanced retention feature comprises a box portion coupled with the at least one stabilizer and with the at least one gripping feature, a spring, an anchor portion, and a neck portion,
wherein the box portion comprises an upper shell portion and a lower shell portion,
wherein the upper and lower shell portions respectively comprise a grooved portion for accommodating the anchor portion,
wherein the box portion comprises at least one material selected from a group consisting essentially of a polymer, and a rigid plastic,
wherein the spring comprises at least one material selected from a group consisting essentially of a metal, an alloy,
wherein the elastic member comprises at least one element selected from a group consisting essentially of a rubber band, and
wherein the flexible collar comprises a material selected from a group consisting essentially of a flexible polymer, an elastomer, and a rubber.

14. A method of fabricating a lighter-holder apparatus for use with a water pipe, the method comprising providing a flexible collar, the flexible collar providing step comprising:
providing at least one gripping feature for accommodating at least one lighter;
providing a hooking feature for facilitating disposition of the apparatus around the water pipe; and
coupling the hooking feature with the at least one gripping feature.

15. The method of claim 14, further comprising providing at least one stabilizer for coupling the hooking feature with the at least one gripping feature,
wherein the at least one gripping feature providing step comprises providing at least one arm and providing at least one grip respectively coupled with the at least one arm for accommodating at least one lighter type and at least one lighter configuration,
wherein the at least one stabilizer providing step comprises providing the at least one stabilizer which maintains an optimal distance between a pair of arms during disposition of the flexible collar around the water pipe, having a given size, and
wherein the at least one stabilizer providing step comprises coupling the hooking feature with the at least one gripping feature in a manner such that the apparatus is ambidextrous by way of reversible orientation.

16. The method of claim 15,
wherein the at least one grip providing step comprises providing a padding feature, and
wherein the padding feature providing step comprises providing a configuration selected from a group consisting essentially of a concave surface for accommodating a lighter having an oval cross-section and a flat surface for accommodating a lighter having a rectangular cross-section.

17. The method of claim 15,
wherein the at least one lighter type comprises an element selected from a group consisting essentially of a permanent lighter and a disposable lighter, and
wherein the at least one lighter comprises a configuration selected from a group consisting essentially of an oval configuration and a rectangular configuration.

18. The method of claim 14,
wherein the flexible collar providing step comprises providing the flexible collar as being frangible for facilitating fit of the apparatus around the water pipe,
wherein the flexible collar providing step comprises providing the flexible collar with an interference fit for facilitating fit of the apparatus around the water pipe,
wherein the hooking feature providing step comprises providing the hooking feature with a thematic feature,
wherein the hooking feature providing step comprises providing at least one hook for accommodating an elastic member, and
wherein the at least one hook providing step comprises providing the at least one hook as being frangible for facilitating fit of the apparatus around the water pipe.

19. The method of claim 14,
wherein the at least one grip providing step comprises providing a concave surface for accommodating a lighter having an oval cross-section,
wherein the at least one arm providing step comprises providing a flat surface for accommodating a lighter having a rectangular cross-section, and
wherein the at least one grip providing step and the at least one arm providing step together comprises providing the at least one grip and the at least one arm as being approximately equal in height.

20. The method of claim 14,
wherein the at least one gripping feature providing step comprises providing the at least one gripping feature as being orientable in a manner selected from a group consisting essentially of in parallel with the flexible collar, perpendicular to the flexible collar, and in any desired angular relation to the flexible collar, and
wherein the flexible collar providing step comprises providing the flexible collar as being capable of accommodating a plurality of water pipe sizes.

21. The method of claim 14, further comprising providing a feature selected from a group consisting essentially of:
at least one rotating feature coupled with the at least one stabilizer and with the at least one gripping feature for facilitating orientation of the at least one gripping feature in relation to the flexible collar; and
at least one enhanced retention feature for increasing a gripping force being applied to the at least one lighter.

22. The method of claim 21,
wherein the at least one rotating feature providing step comprises providing a ring portion, providing an anchor portion, providing a shell portion, and providing a box portion,
wherein the ring portion providing step comprises coupling the ring portion with the at least one stabilizer and the anchor portion, and
wherein the shell portion providing step comprises coupling the shell portion with the at least one gripping feature by way of the at least one arm and with the box portion.

23. The method of claim 21,
wherein the at least one enhanced retention feature providing step comprises providing a box portion, providing a spring, providing an anchor portion, and providing a neck portion,
wherein the box portion providing step comprises providing an upper shell portion and providing a lower shell portion,
wherein the upper and lower shell portion providing steps respectively comprise providing a corresponding grooved portion for accommodating the anchor portion, and
wherein the enhanced retention feature providing step comprises coupling the box portion with the at least one stabilizer and the at least one gripping feature.

24. The method of claim 23,
wherein the box portion providing step comprises providing at least one material selected from a group consisting essentially of a polymer, a rigid plastic, and
wherein the spring providing step comprises providing at least one material selected from a group consisting essentially of a metal, and an alloy.

25. The method of claim 18,
wherein the elastic member providing step comprises providing at least one element selected from a group consisting essentially of a rubber band, and
wherein the flexible collar providing step comprises providing a material selected from a group consisting essentially of a flexible polymer, an elastomer, and a rubber.

26. The method of claim 14, further comprising providing:
at least one stabilizer for coupling the hooking feature with the at least one gripping feature; and
a feature selected from a group consisting essentially of:
at least one rotating feature coupled with the at least one stabilizer and with the at least one gripping feature for facilitating orientation of the at least one gripping feature in relation to the flexible collar; and
at least one enhanced retention feature for increasing a gripping force being applied to the at least one lighter,
wherein the at least one gripping feature providing step comprises providing at least one arm and providing at least one grip respectively coupled with the at least one arm for accommodating at least one lighter type and at least one lighter configuration,
wherein the at least one stabilizer providing step comprises coupling the hooking feature with the at least one gripping feature in a manner such that the apparatus is ambidextrous by way of reversible orientation,
wherein the at least one grip providing step comprises providing a padding feature,
wherein the padding feature providing step comprises providing a configuration selected from a group consisting essentially of a concave surface for accommodating a lighter having an oval cross-section and a flat surface for accommodating a lighter having a rectangular cross-section,
wherein the at least one lighter type comprises an element selected from a group consisting essentially of a permanent lighter and a disposable lighter,
wherein the at least one lighter comprises a configuration selected from a group consisting essentially of an oval configuration and a rectangular configuration.
wherein the flexible collar providing step comprises providing the flexible collar as being frangible for facilitating fit of the apparatus around the water pipe,
wherein the flexible collar providing step comprises providing the flexible collar with an interference fit for facilitating fit of the apparatus around the water pipe,
wherein the hooking feature providing step comprises providing the hooking feature with a thematic feature,
wherein the hooking feature providing step comprises providing at least one hook for accommodating an elastic member,
wherein the at least one hook providing step comprises providing the at least one hook as being frangible for facilitating fit of the apparatus around the water pipe,
wherein the at least one grip providing step comprises providing a concave surface for accommodating a lighter having an oval cross-section,
wherein the at least one arm providing step comprises providing a flat surface for accommodating a lighter having a rectangular cross-section,
wherein the at least one grip providing step and the at least one arm providing step together comprises providing the at least one grip and the at least one arm as being approximately equal in height,
wherein the at least one gripping feature providing step comprises providing the at least one gripping feature as being orientable in a manner selected from a group consisting essentially of in parallel with the flexible collar, perpendicular to the flexible collar, and in any desired angular relation to the flexible collar,
wherein the flexible collar providing step comprises providing the flexible collar as being capable of accommodating a plurality of water pipe sizes,
wherein the at least one rotating feature providing step comprises providing a ring portion, providing an anchor portion, providing a shell portion, and providing a box portion,
wherein the ring portion providing step comprises coupling the ring portion with the at least one stabilizer and the anchor portion,
wherein the shell portion providing step comprises coupling the shell portion with the at least one gripping feature by way of the at least one arm and with the box portion,
wherein the at least one enhanced retention feature providing step comprises providing a box portion, providing a spring, providing an anchor portion, and providing a neck portion,
wherein the box portion providing step comprises providing an upper shell portion and providing a lower shell portion,
wherein the upper and lower shell portion providing steps respectively comprise providing a corresponding grooved portion for accommodating the anchor portion,
wherein the at least one enhanced retention feature providing step comprises coupling the box portion with the at least one stabilizer and the at least one gripping feature,
wherein the box portion providing step comprises providing at least one material selected from a group consisting essentially of a polymer, a rigid plastic,
wherein the spring providing step comprises providing at least one material selected from a group consisting essentially of a metal, an alloy, wherein the elastic member providing step comprises providing at least one element selected from a group consisting essentially of a rubber band, and
wherein the flexible collar providing step comprises providing a material selected from a group consisting essentially of a flexible polymer, an elastomer, and a rubber.

27. A method of using a lighter-holder apparatus with a water pipe, the method comprising:
providing a flexible collar, the flexible collar providing step comprising:
providing at least one gripping feature for accommodating at least one lighter;
providing a hooking feature for facilitating disposition of the apparatus around the water pipe; and
coupling the hooking feature with the at least one gripping feature;
disposing the flexible collar around the water pipe; and
disposing at least one lighter in the at least one gripping feature.

28. The method of claim 27, further comprising disposing an elastic member around the hooking feature.
